(19) United States
(12) Patent Application Publication
(10) Pub. No.: US 2024/0337165 A1
(43) Pub. Date: Oct. 10, 2024

(54) SELF CLEANING FILTERING SYSTEM

(71) Applicant: SAUDI ARABIAN OIL COMPANY, Dhahran (SA)

(72) Inventors: Mohannad A. GIZANY, Dhahran (SA); Wenrong MEI, Dhahran (SA)

(73) Assignee: SAUDI ARABIAN OIL COMPANY, Dhahran (SA)

(21) Appl. No.: 18/298,050

(22) Filed: Apr. 10, 2023

(51) Int. Cl. E21B 21/06; B01D 29/35; B01D 29/60; B01D 29/64; B01D 29/94; B01D 35/147

(52) U.S. Cl. CPC E21B 21/065; B01D 29/35; B01D 29/606; B01D 29/6476; B01D 29/94; B01D 35/147

(57) ABSTRACT

A self-cleaning filter apparatus for a wellbore fluid system includes an outer housing in fluid communication with a source of a fluid via an inlet port, a filter element positionable within the outer housing and including perforations through which the fluid may pass while obstructing passage of impurities, an outlet port provided on the outer housing for discharging filtered fluid from the outer housing, at least one data collection device operable to detect a parameter indicative of a flow of the fluid through the filter element, and at least one scraper blade disposed within the outer housing and engageable with an upstream wall of the filter element to dislodge accumulated impurities from the upstream wall in response to detecting a parameter indicative of a reduction in flow of the fluid through the filter element with the at least one data collection device.

### FIELD OF THE DISCLOSURE

The present disclosure relates to fluid filtration, and more specifically, to a self-cleaning filtering system for improving the quality of water injected into a subterranean formation through an injection wellbore.

### BACKGROUND OF THE DISCLOSURE

Hydrocarbons exist in subterranean geologic formations in liquid and gaseous forms. Often when producing these hydrocarbons to a surface location, water is also produced along with the hydrocarbons. The water may originate from naturally occurring reservoirs within the subterranean formation or the water may have been injected into the subterranean formation as part of a treatment procedure (e.g., formation stimulation, water or steam flooding, etc.). The produced water may be reinjected into the same or a different subterranean formation in order to dispose of the water in a safe and efficient manner, or alternatively to maintain downhole pressure. Often, a new dedicated injection wellbore may be drilled for injecting the produced water, although repurposed or converted wellbores may also be used for injection purposes.

The water that is to be injected into an injection wellbore often contains impurities. For example, the water may contain salts, various chemicals present in the oilfield industry, suspended solids, and the like. The presence of these impurities can detrimentally affect the injection wellbore, e.g., by plugging the pores in the geologic formation, thereby limiting the ability to inject fluids in the future.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a fluid system for filtering a fluid includes an outer housing through which the fluid may be passed. An inlet port is defined in the outer housing for receiving the fluid to be filtered into the outer housing. The inlet port is fluidly coupled to a source of the fluid. An outlet port is defined in the outer housing for discharging the filtered fluid from the outer housing. A filter element is disposed within the outer housing between the inlet port and the outlet port. The filter element includes perforations therein such that the filter element permits passage of the fluid through the perforations and obstructs passage of impurities from the fluid when the fluid flows between the inlet port and the outlet port. A dirty fluid chamber for introducing the fluid to the filter element is defined between the inlet port and the filter element and a clean fluid chamber for receiving the fluid from the filter element is defined between the filter element and the outlet port. At least one data collection device is operable to detect a parameter indicative of a flow of the fluid through the filter element, and at least one scraper blade is disposed within the dirty fluid chamber and engaged with a wall of the filter element. The scraper blade is operable to wipe the wall of the filter element and dislodge accumulated impurities therefrom in response to detecting a parameter indicative of a reduction in flow of the fluid through the filter element with the at least one data collection device.

In another embodiment, a method of filtering a fluid includes flowing the fluid to be filtered into a dirty fluid chamber defined in an outer housing. The dirty fluid chamber is defined between an inlet port of the outer housing and a filter element disposed within the outer housing. The method further includes passing the fluid through the filter element into a clean fluid chamber defined in the outer housing between the filter element and an outlet port of the outer housing and obstructing passage of impurities in the fluid into the clean fluid chamber with the filter element. The method includes detecting a parameter with at least one data collection device, the parameter indicative of a reduction in flow of the fluid through the filter element, and the method includes wiping a wall of the filter element with at least one scraper blade disposed within the dirty fluid chamber to dislodge accumulated impurities from the wall of the filter element in response to detecting the parameter indicative of the reduction in flow of the fluid through the filter element with the at least one data collection device.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a cross-sectional view of a wellbore fluid system including a self-cleaning filter apparatus coupled between a source of injection fluid and an injection wellbore in accordance with one or more aspects of the present disclosure.

FIG. 2 is a side view schematic of the self-cleaning filter apparatus of FIG. 1 illustrating interior components thereof including a cylindrical screen element, a rotary scraper and scaling elements.

FIG. 3 is a top view schematic of the rotary scraper of FIG. 2.

FIG. 4 is a top view schematic view self-cleaning apparatus of FIG. 1 illustrating a bypass line extending around the self-cleaning filter apparatus.

FIG. 5 is a flowchart illustrating a procedure for operating the self-cleaning filter apparatus in an injection procedure in accordance with one or more aspects of the present disclosure.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to a self-cleaning filter apparatus, which may be employed in a wellbore injection system to improve the quality of the injected fluids. The self-cleaning filter apparatus may include a cylindrical filter element with a rotary scraper therein. The rotary scraper may be operated to remove impurities from the filter element in response to detecting a pressure drop across the filter element outside a predetermined range. A bypass line may be provided around the filter element to facilitate maintenance of the self-cleaning filter apparatus.

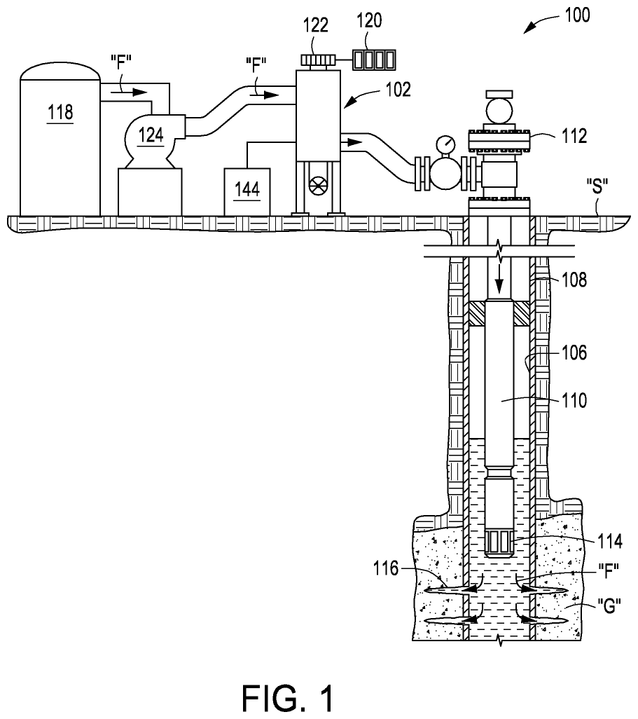

FIG. 1 is a schematic view of an example wellbore fluid system 100 including a self-cleaning filter apparatus 102, in accordance with one or more exemplary embodiments of the disclosure. The wellbore fluid system 100 includes an injection wellbore 106 for receiving an injection fluid “F”. In some cases, the injection fluid “F” may comprise water previously produced from the wellbore 106 or another wellbore (not shown). Although FIG. 1 illustrates the self-cleaning filter apparatus 102 used in conjunction with the injection wellbore fluid system 100, those skilled in the art will appreciate that the self-cleaning filter apparatus 102 may be employed in alternative flow lines and applications as well.

The injection wellbore 106 extends from a surface location “S” and traverses a geologic formation “G.” In the illustrated example, the wellbore 106 is substantially vertical. In other embodiments, aspects of this disclosure may be practiced in wellbores exhibiting a wide variety of vertical, directional, deviated, slanted and/or horizontal portions, and may extend along any trajectory through the geologic formation “G.” As illustrated in FIG. 1, the wellbore 106 is partially lined with a casing string 108, however, in other embodiments, the wellbore 106 may be uncased without departing from the scope of the disclosure.

In the illustrated embodiment, the wellbore fluid system 100 includes an injection tubing string 110 extending into the wellbore 106 from a wellhead 112 situated at the surface location “S.” The injection tubing string 110 may be constructed of a series of pipe sections coupled to one another in an end-to-end manner, or in some embodiments, the injection tubing string 110 may be a continuous string of flexible tubing, such as coiled tubing or the like. One or more outlet ports 114 are provided or defined in the injection tubing string 110 and permit the injection fluid “F” to be discharged from an interior of the injection tubing string 110 into the injection wellbore 106. The wellhead 112 generally provides a suspension point for the casing string 108 and the injection tubing string 110 and also provides a flow path for injection fluids “F” to be pumped into the injection tubing string 110. Perforations 116 may extend through the casing string 108 into the geologic formation, and permit the injection fluids “F” to enter the geologic formation “G” from the injection wellbore 106.

At the surface location “S” the wellbore fluid system 100 includes a source 118 of injection fluid “F” upstream of the self-cleaning filter apparatus 102. As mentioned above, the injection fluid “F” may include water or brine previously produced from the wellbore 106 or another wellbore (not shown), and may include various impurities and solids therein. The source 118 is illustrated in FIG. 1 as a storage tank, but in other embodiments, the formation fluid “F” may be provided directly from a holding pond, a remote wellbore, a pipeline or other sources, without departing from the scope of the disclosure. The formation fluid “F” exiting the source 118 may pass through the self-cleaning filter apparatus 102 to remove solids and other impurities therefrom.

An electrical power source 120 provides electrical power to a motor 122 of the self-cleaning filter apparatus 102, which may be operated periodically to clean the impurities from the self-cleaning filter apparatus 102, as described in greater detail below. A high-pressure pump 124 is provided between the source 118 and the self-cleaning filter apparatus 102. The pump 124 draws the injection fluid “F” from the storage tank (source 118), boosts the pressure and forces the injection fluid “F” flowing downstream toward the injection wellbore 106 receiving the injection fluid “F.” Since impurities have been removed from the injection fluid “F” before entering the injection wellbore 106, pores in the geologic formation “G” will remain open, and the geologic formation “G” may continue to accept injection fluid from the source 118 at the surface location “S.”

A controller 144 may be provided to operate the self-cleaning filter apparatus 102. The controller 144 is operably coupled to the self-cleaning filter apparatus 102 to provide instructions and command signals thereto. In some embodiments, the controller 144 may also be communicatively coupled to one or more data collection devices (e.g., pressure gauges 424, 426 of FIG. 4) to receive data therefrom. In some embodiments, the controller 144 may be a computer-based system that may include a processor, a memory storage device, and programs and instructions accessible to the processor for executing the instructions and thereby utilizing the data stored in the memory storage device to carry out the processes described herein. Additionally or alternatively, the controller 144 may include manual controls that may be manipulated by an operator to control any of the procedures and equipment described herein.

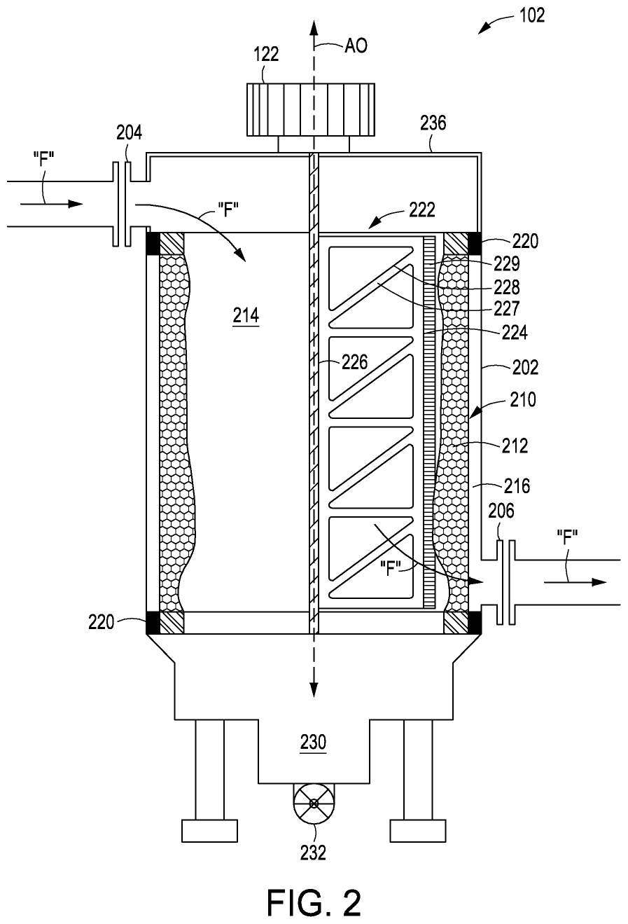

FIG. 2 is an enlarged, schematic side view of the self-cleaning filter apparatus 102, according to one or more embodiments of the present disclosure. As illustrated, the self-cleaning filter apparatus 102 includes an outer housing 202, which is generally cylindrical in shape. An inlet port 204 defined at an upper end of the outer housing 202 may receive “dirty” injection fluid “F” into the self-cleaning filter apparatus 102 and an outlet port 206 defined at a lower end of the outer housing 202 may discharge “clean” injection fluid “F” from the self-cleaning filter apparatus 102. As used herein, “dirty” describes injection fluid “F” that has not yet passed through a filter element 210, and “clean” describes injection fluid after passing through the filter element 210.

The filter element 210 may be constructed in a cylindrical shape from a material such as plastic, ceramic or metal. A corrosion resistant material such as chromium 13 stainless steel may be useful in applications with a corrosive injection fluid “F” may pass therethrough. The filter element 210 includes perforations therein to allow the injection fluid “F” to pass through. The size of the perforations 212 may be in the range of about 100 microns to about 150 microns, but larger or smaller perforations 212 may be provided to accommodate specific flow rates or the removal of specific particulates or debris. For example, perforations 212 with a diameter of about 25, 50, 75, 100, 150 or 200 microns may be provided. In some embodiments, the filter element 210 may be constructed from multiple filter layers, wherein each layer includes perforations 212 of different sizes.

Dirty injection fluid “F” enters the self-cleaning filter apparatus 102 through the inlet port 204 and immediately enters an interior region 214 defined within of the cylindrical filter element 210. The interior region 214 defines a dirty fluid chamber within the outer housing 202 and is in fluid communication with an annular space 216 defined between the filter element 210 and the outer housing 202 through the apertures of the filter element 210. After passing radially outward through the filter element 210, the clean injection fluid “F” enters the annular space 216, which defines a clean fluid chamber within the outer housing 202. The clean injection fluid “F” may then be discharged from the self-cleaning filter apparatus 102 through the outlet port 206.

In some embodiments, annular sealing elements 220 are provided above and below the annular space 216 to isolate the clean injection fluid “F” from the dirty injection fluid “F.” The sealing elements 220 may be constructed of one or more elastomeric materials, and should be effective to maintain a seal at high temperatures and pressures, for example, about 80 degrees Celsius and 2000 psi.

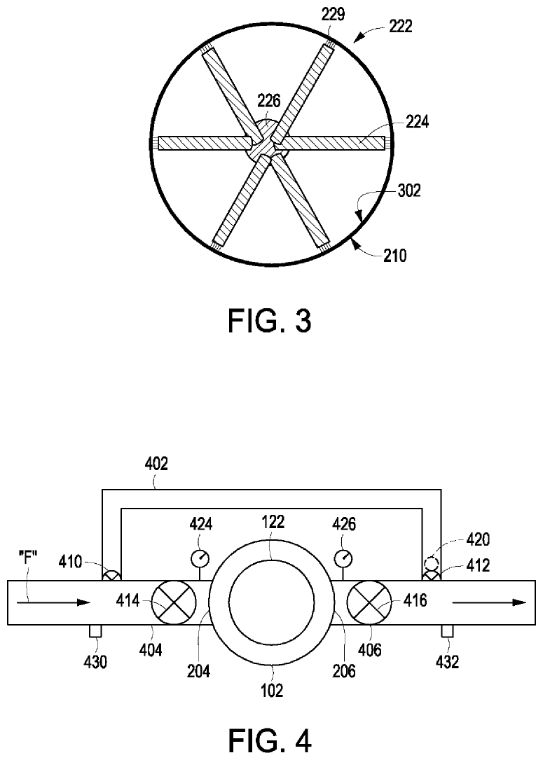

The self-cleaning filter apparatus 102 includes a rotary scraper 222 rotatably disposed within the interior region 214 of the filter element 210. The rotary scraper 222 includes one or more scraper blades 224 extending radially outward from a central rotor 226 and toward an upstream or inner wall of the filter element 210 (see FIG. 3). The scraper blades 224 may be constructed with a plurality of ribs 227 with openings 228 defined therebetween. In some embodiments, a radially outermost edge of the scraper blades 224 may include bristles or a brush 229 operable to engage the upstream or inner wall 302 (FIG. 3) of the filter element 210 as the scraper blades 224 rotate. In other embodiments, the brush 229 may comprise or otherwise be replaced with a rubber wiper arranged to engage the inner wall of the filter element 210 and dislodge filter cake or other impurities from the inner wall 302 as the rotary scraper 222 is operated.

The central rotor 226 is operably coupled to the motor 122 to rotate about a vertical axis A0 when the motor 122 is operated. Operation of the motor 122 rotates the rotor 226 and the scraper 224 such that the scraper 224 may wipe or scrape any impurities (e.g., “filter cake”) that may have collected on the inner wall of the filter element 210. The motor 122 may be operated at a relatively slow speed, for example about 18-30 revolutions per hour, to remove impurities from the filter element 210. In some embodiments, the central rotor 226 may alternatively be rotated through manual manipulation of the motor 122. A couple of manual turns of the rotor 226, for example, may be sufficient to scrape off any filter cake accumulated on the inner wall of the filter element 210 in the event that electricity is unavailable.

Impurities removed from the inner wall of the filter element 210 may settle under gravitational forces to a collection bin 230 arranged vertically below the filter element 210. A debris discharge valve 232 may be provided at a lower end of the collection bin 230, through which the impurities filtered from the injection fluid may be removed from the self-cleaning filter apparatus 102. The impurities may include residual oil that may be recovered after the impurities are removed through the debris discharge valve 232. In some cases, the accumulated impurities may be flushed from the collection bin 230 by passing a volume of a flushing fluid through the debris discharge valve 232. In some embodiments, the volume of flushing fluid may about twice a volume of the filter element 210, and in some embodiments, the flushing fluid may include the injection fluid “F.” The flushing fluid and the impurities removed from the collection bin 230 may be collected in a container (not shown) where the residual oil may be permitted to float to the top of the flushing fluid, e.g., over many hours of settling. The residual oil may then be syphoned off the top and collected for further processing.

Maintenance on the self-cleaning filter apparatus 102 may be required periodically. For example, the filter element 210 may need to be replaced or the scaling elements 220 may need to be inspected from time to time. To accomplish this, the upper end of the outer housing 202 may comprise a removable cover 236, which may be detached and removed to provide access to the filter element 210 and the sealing elements 220 at the upper end of the annular space 216. In some embodiments, the entire outer housing 202 may be also be removed from the collection bin 230 to provide access to the sealing elements 220 at the lower end of the annular space 216.

FIG. 3 is a top view of the rotary scraper 222, according to one or more embodiments. As illustrated, the rotary scraper 222 includes a plurality of scraper blades 224 extending from the central rotor 226 and toward an interior wall 302 of the filter element 210. The brushes 229 at the end radially outermost ends of the scraper blades 224 may be configured to engage or come into close contact with the interior wall 302. In other embodiments, the scraper blade 224 may comprise a spiral blade that has a consistent single-point contact with the interior wall 302. When the rotor 226 is rotated, the scraper blades 224 clean, wipe or brush the interior wall 302 to dislodge filter cake or other impurities to achieve self-cleaning of the filter element 210.

Referring now to FIG. 4, in some embodiments, a bypass line 402 may extend around the self-cleaning apparatus 102. More specifically, the bypass line 402 may extend between an input pipe 404 coupled to the inlet port 204 and an output pipe 406 coupled to the outlet port 206. In normal operations, the bypass line 402 may be closed at bypass valves 410. 412 disposed at the ends of the bypass line 402. Main valves 414, 416 disposed within the input and output pipes 404, 406, respectively, may be open such that injection fluid “F” may pass freely through the input pipe 404, the self-cleaning filter apparatus 102 and the output pipe 406.

When maintenance of the self-cleaning filter apparatus 102 is required, the main valves 414, 416 may be closed and the bypass valves 410, 412 may be opened to divert the flow of injection fluid “F” through the bypass line 402 instead of through the self-cleaning filter apparatus 102. Thus, injection of the injection fluid “F” may continue while the maintenance of the self-cleaning filter apparatus 102 is ongoing. Once the maintenance of the self-cleaning filter apparatus 102 is completed, the bypass valves 410, 412 may again be operated to close the bypass line 402. Any fluid remaining in the bypass line 402 may be removed through a drain 420 provided near a lower end of the bypass line 402. In some embodiments, an inert gas may be injected through the drain 420 to prevent corrosion of the interior of the bypass line 402 when the bypass line 402 is not in use. Once the bypass valves 410, 412 are closed, the main valves 414, 416 may again be opened to reestablish flow through the self-cleaning filter apparatus 102 while the bypass line 402 is drained.

To monitor the operation of the self-cleaning filter apparatus 102, an upstream pressure gauge 424 may be provided in input pipe 404 and a downstream pressure gauge 426 may be provided in the output pipe 406. The pressure gauges 424, 426 may be employed to monitor a pressure differential experienced across the self-cleaning filter apparatus 102. An increasing pressure differential across the self-cleaning filter apparatus 102 may be an indication that filter cake is accumulating on the filter element 210 (FIG. 2). When the pressure differential reaches an upper predetermined threshold, for example, 7 or 10 psi, a signal may be sent to the motor 122 to commence operation to remove filter cake that may have accumulated on the filter element 210, as generally described above. The motor 122 may be operated for a predetermined time period or the motor 122 may be operated until the pressure differential reaches a lower predetermined threshold, for example 4 or 5 psi.

Additionally or alternatively, the self-cleaning filter apparatus 102 may be flushed when the pressure differential reaches the upper predetermined threshold (7 or 10 psi). In such applications, the debris discharge valve 232 (FIG. 2) may be opened to flush the injection fluid “F” from the interior chamber interior region 214 through the collection bin 230 to permit the impurities collected in the collection bin 230 to be discharged to a mud pit or a portable processing facility to remove residual oil. With the debris discharge valve 232 opened, the interior of the self-cleaning filter apparatus 102 may be cleaned until the pressure differential reaches the lower predetermined threshold (4 or 5 psi).

In some embodiments, an upstream fluid sampling port 430 is provided in the input pipe 404 to monitor a quality of the dirty injection fluid “F” and a downstream fluid sampling port 432 may be provided in the output pipe 406 to monitor the quality of the clean injection fluid “F.” A decreasing quality of the clean injection fluid “F” may be an indication that the filter element 210 may need to be inspected and replaced. For example, where the residual oil content or the clean injection fluid “F” reaches a predetermined threshold, a flushing operation may be conducted and/or the motor 122 may be operated. The oil content of the injection fluid “F” may be monitored automatically with an online residual oil analyzer or a similar tool coupled to the downstream fluid sampling port 432.

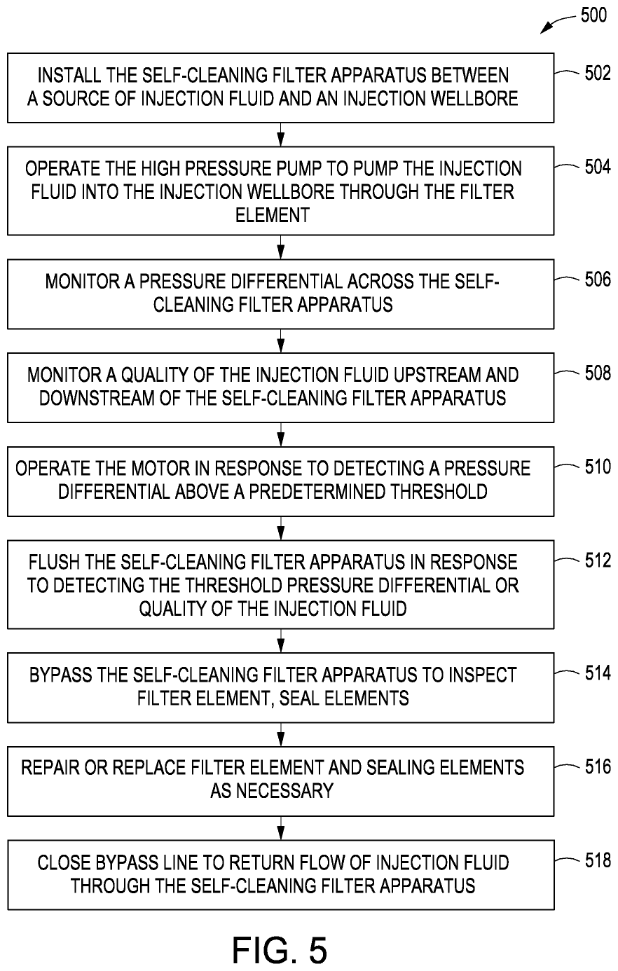

Referring now to FIG. 5, and with continued reference to FIGS. 1-4, illustrated is a schematic of an example method or procedure 500 for operating the wellbore fluid system 100 of FIG. 1 in accordance with the present disclosure. Initially at step 502, the self-cleaning filter apparatus 102 may be installed between a source 118 of injection fluid “F” and an injection wellbore 106. The injection fluid “F” may be water or brine that has been produced from a subterranean formation, and the self-cleaning filter apparatus 102 may be employed to improve the quality of the water before re-injecting the water back downhole. By removing impurities from the injection fluid “F,” damage to the injection wellbore 106 may be prevented, thereby preventing expensive and time consuming wellbore treatments. Additionally, residual oil may be collected from the impurities removed by the self-cleaning filter apparatus 102.

At step 504, the high pressure pump 124 is operated to pump the injection fluid “F” into the injection wellbore 106 through the filter element 210. As the injection fluid “F” is pumped through the filter element 210 and into the injection wellbore 106, a pressure differential across the self-cleaning filter apparatus 102 is monitored, as at step 506. The controller 144 may be communicatively coupled to the upstream and downstream pressure gauges 424, 426, and may determine a real-time pressure differential from pressure readings provided by the pressure gauges 424, 426. The controller 144 may determine a pressure differential at regular intervals (e.g., every second), and compare the observed pressure differential to a predetermined threshold stored within the controller 144. In other embodiments, the controller 144 may monitor other parameters indicative of a reduction in flow of the fluid through the filter element 210.

Similarly, at step 508, a quality of the injection fluid “F” upstream and downstream of the self-cleaning filter apparatus 102 may be monitored. For example, the controller 144 may be communicatively coupled to one or more residual oil analyzers or similar tools coupled to the upstream and downstream fluid sampling ports 430, 432. The controller 144 may compare the oil content of the fluid exiting the self-cleaning filter apparatus to a predetermined threshold, or monitor another parameter indicative of a quality of the fluid exiting the outlet port 206.

At step 510, the motor 122 may be operated in response to detecting a pressure differential above the predetermined threshold (e.g., 7 or 10 psi). In some embodiments the controller 144 may trigger operation of the motor 122 in response to detecting the pressure differential above the predetermined threshold. In some embodiments, the motor 122 may be operated at a slow speed (e.g., 18-30 revolutions per hour) to remove impurities from the filter element 210. In other embodiments, or in addition thereto, the motor 122 may be operated for a predetermined number of revolutions or a predetermined time period, or may be operated until the controller 144 determines that the pressure differential has fallen to a lower predetermined threshold (e.g., 4 or 5 psi.). Impurities or debris wiped from the filter element 210 may settle into a collection bin 230.

At step 512, the self-cleaning filer apparatus 102 may be flushed in response to detecting the threshold pressure differential or quality of the injection fluid “F”. For example, if the oil content of the injection fluid “F” at the fluid sampling port 432 is above a predetermined threshold, the collection bin 230 may be full. The controller 144 may instruct the debris discharge valve 232 to open to allow the injection fluid “F” in the interior region 214 to carry the debris collected in the collection bin 230 to a facility for collecting the residual oil. Steps 504 through 512 may continue or be repeated until maintenance or replacement of the filter element 210 is necessary.

At step 514, the self-cleaning filter apparatus 102 may be bypassed to inspect the filter element 210 and the sealing elements 220. The controller 144 or an operator may operate the bypass valves 410, 412 to permit the injection fluid “F” to flow through the bypass line 402. In other embodiments, the main valve 414 may be closed if injection into the injection wellbore 106 may be interrupted. With the injection fluid “F” flowing through the bypass line 402, the outer housing 202 of the self-cleaning apparatus 102 may be opened.

At step 516, the filter element 210 and/or the sealing elements 220 may be inspected, repaired and/or replaced as necessary. At step 518, the bypass line 402 may be closed to resume flow through the self-cleaning filter apparatus 102. The bypass line 402 may be cleaned and dried as the self-cleaning filter apparatus 102 continues to operate.

It should be appreciated that the steps of the procedure 500 may be conducted in alternate orders. Also not every step may be performed in every procedure employing the self-cleaning filter apparatus 102.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including.” “comprises”, and/or “comprising.” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A self-cleaning filter apparatus for a wellbore fluid system, comprising:
an outer housing in fluid communication with a source of a fluid via an inlet port;
a filter element positionable within the outer housing and including perforations through which the fluid may pass while obstructing passage of impurities;
an outlet port provided on the outer housing for discharging filtered fluid from the outer housing;
at least one data collection device operable to detect a parameter indicative of a flow of the fluid through the filter element; and
at least one scraper blade disposed within the outer housing and engageable with an upstream wall of the filter element to dislodge accumulated impurities from the upstream wall in response to detecting a parameter indicative of a reduction in flow of the fluid through the filter element with the at least one data collection device.

2. The apparatus of claim 1, wherein the filter element is cylindrical and the at least one scraper blade is mounted to a central rotor rotatable about a central axis extending through the filter element.

3. The apparatus of claim 2, further comprising an electric motor operably coupled to the rotor to rotate the motor in response to detecting the parameter indicative of the reduction in the flow of the fluid through the filter element.

4. The apparatus of claim 3, wherein the at least one data collection device includes:
an upstream pressure sensor operable to detect a pressure of the fluid upstream of the filter element; and
a downstream pressure sensor operable to detect a pressure of the fluid downstream of the filter element, and
wherein the electric motor is operable to rotate the rotor in response to the upstream and downstream pressure sensors detecting a pressure differential above a predetermined threshold.

5. The apparatus of claim 4, further comprising a controller communicatively coupled to the upstream and downstream pressure sensors and the electric motor, the controller being operable to compare the pressure differential to the predetermined threshold and to instruct the motor to operate when the pressure differential is above the predetermined threshold.

6. The apparatus of claim 1, further comprising a collection bin disposed below the filter element for receiving the accumulated impurities removed from the filter element.

7. The apparatus of claim 6, further comprising a debris discharge valve provided in the collection bin and operable to open in response to detecting a quality of the fluid exiting the outlet port.

8. The apparatus of claim 1, further comprising a bypass line extending around the outer housing and at least one valve operable to direct the fluid into either the outer housing or the bypass line.

9. A fluid system, comprising:
the self-cleaning apparatus of claim 1;
an injection wellbore in fluid communication with the outlet port; and
a pump operable to pump the filtered fluid from the outlet port into the injection wellbore.

10. A method of filtering a fluid, the method comprising:
flowing the fluid into an outer housing via an inlet port provided on the outer housing;
circulating the fluid through a filter element positioned within the outer housing, the filter element including perforations through which the fluid may pass;
obstructing passage of impurities in the fluid through the filter element;
detecting a parameter indicative of a reduction in flow of the fluid through the filter element with at least one data collection device;
triggering operation of at least one scraper blade disposed within the outer housing upon detecting the parameter indicative of the reduction in flow of the fluid through the filter element; and
dislodging accumulated impurities from an upstream wall of the filter element as the at least one scraper blade operates within the outer housing.

11. The method of claim 10, wherein triggering operation of the at least one scraper blade includes operating an electric motor operably coupled to the at least one scraper blade to rotate the at least one scraper about a central axis defined through the filter element.

12. The method of claim 11, further comprising:
detecting a pressure of the fluid upstream and downstream of the filter element;
determining a pressure differential across the filter element;
comparing the differential pressure to a predetermined threshold; and
instructing the motor to operate in response to the differential pressure exceeding the predetermined threshold.

13. The method of claim 10, further comprising flushing the fluid from the outer housing in response to detecting a parameter indicative of a quality of the fluid exiting the outlet port.

14. The method of claim 13, wherein flushing the fluid from the outer housing includes opening a debris discharge valve defined in a collection bin disposed below outer housing and arranged to receive the accumulated impurities dislodged from the filter element.

15. The method of claim 10, further comprising pumping the fluid from the outlet port into an injection wellbore.
